(19) United States
(12) Patent Application Publication
(10) Pub. No.: US 2012/0268495 A1
(43) Pub. Date: Oct. 25, 2012

(54) APPARATUS AND METHOD FOR ADJUSTING RESOLUTION OF APPLICATION IN WIRELESS TERMINAL

(75) Inventors: Won-Kyu LEE, Goyang-si (KR); Kyoung-Yong Lee, Suwon-si (KR)

(73) Assignee: Samsung Electronics Co., Ltd., Gyeonggi-do (KR)

(21) Appl. No.: 13/450,904

(22) Filed: Apr. 19, 2012

Related U.S. Application Data
(60) Provisional application No. 61/477,012, filed on Apr. 19, 2011.

(30) Foreign Application Priority Data
Apr. 17, 2012 (KR) 10-2012-0039457

(51) Int. Cl. G09G 5/00

(52) U.S. Cl. 345/660

(57) ABSTRACT

Disclosed is an apparatus and a method of adjusting a resolution of an application in a wireless terminal, which can automatically adjust a resolution of an application to be appropriate for a resolution of a wireless terminal. The apparatus includes a display unit for displaying an application having a resolution identically adjusted to a resolution of a wireless terminal and a controller for controlling such that when execution of the application is selected, the application is executed by adjusting the resolution of the application to be identical to the resolution of the wireless terminal.

### PRIORITY

This application claims priority under 35 U.S.C. §119 to a U.S. Provisional Patent Application Ser. No. 61/477,012, which was filed in the USPTO on Apr. 19, 2011, and Korean Patent Application Serial No. 10-2012-0039457, which was filed in Korean Intellectual Property Office on Apr. 17, 2012, the entire disclosure of each of which are incorporated herein by reference.

### BACKGROUND OF THE INVENTION

1. Field of the Invention

The present invention generally relates to an apparatus and a method of adjusting a resolution of an application in a wireless terminal, and more particularly to an apparatus and a method which can automatically adjust a resolution of an application to be appropriate for a resolution of a wireless terminal.

2. Description of the Related Art

During execution of an application in a wireless terminal, a scheme of displaying the application in a part or over the entirety of a screen of the portable terminal by scaling a frame buffer when a base resolution of a Graphical User Interface (GUI) written in the application is different from a resolution of the wireless terminal.

However, the scaling of the frame buffer itself, which corresponds to a method of increasing/decreasing a rasterized image, may deteriorate the quality of the resolution of the application displayed on the screen of the wireless terminal. Further, since the scaling of an image of the application should be performed every time the screen of the wireless terminal is renewed, performance may seriously deteriorate depending on the wireless terminal, and the quality of a component, such as a font, displayed in a vector scheme may deteriorate.

Further, when the resolution of the wireless terminal is different from the resolution of the application, the image of the application may be scaled by applying the same ratio to the resolution in horizontal and vertical aspects such that an aspect ratio of the resolution is maintained.

However, since the uniform scaling to maintain an aspect ratio is performed in the scaling of the image of the application by applying the same ratio to the resolution in horizontal and vertical aspects, when the resolution of the application scaled by applying the same aspect ratio horizontally and vertically is different from the resolution of the screen of the wireless terminal, the screen of the application may not be fully displayed, or may be too small so as to not fill up the screen of the wireless terminal.

### SUMMARY OF THE INVENTION

Accordingly, the present invention has been made to solve the above-stated problems occurring in the prior art, and the present invention provides an apparatus and a method of adjusting a resolution of an application in a wireless terminal, by which the resolution of the application can be automatically adjusted to be appropriate for a resolution of the wireless terminal.

In accordance with an aspect of the present invention, there is provided an apparatus for adjusting a resolution of an application in a wireless terminal, the apparatus including a display unit for displaying an application having a resolution adjusted to be identical to a resolution of a wireless terminal; and a controller for controlling such that when execution of the application is selected, the application is executed by adjusting the resolution of the application to be identical to the resolution of the wireless terminal.

In accordance with another aspect of the present invention, there is provided a method of adjusting a resolution of an application in a wireless terminal, the method including when execution of an application is selected, comparing a resolution of the application and a resolution of the wireless terminal; and, when the resolution of the wireless terminal is different from the resolution of the application, executing the application by adjusting the resolution of the application to be identical to the resolution of the wireless terminal.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a wireless terminal according to an embodiment of the present invention;

FIGS. 2A and 2B are flowcharts illustrating a process of adjusting a resolution of an application in a wireless terminal according to an embodiment of the present invention; and

FIGS. 3 and 4 illustrate the process of FIGS. 2A and 2B.

### DETAILED DESCRIPTION OF EMBODIMENTS OF THE PRESENT INVENTION

Hereinafter, the embodiments of the present invention will be described in detail with reference to the accompanying drawings. In the following description, the same elements will be designated by the same reference numerals although they are shown in different drawings.

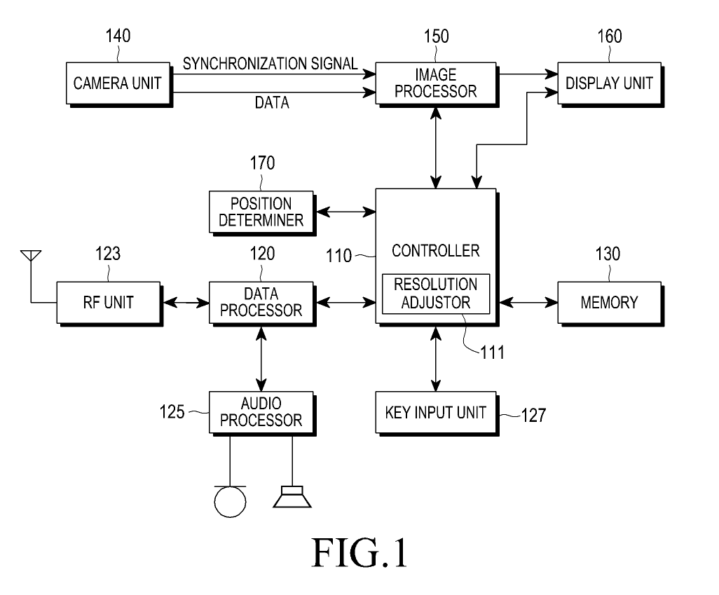

FIG. 1 is a block diagram illustrating a wireless terminal according to an embodiment of the present invention.

Referring to FIG. 1, a Radio-Frequency (RF) unit 123 performs a wireless communication function of the portable terminal. The RF unit 123 includes an RF transmitter for up-converting and amplifying a frequency of a transmitted signal and an RF receiver for low-noise amplifying a received signal and down-converting a frequency. A data processor 120 includes a transmitter for encoding and modulating the transmitted signal and a receiver for demodulating and decoding the received signal. That is, the data processor 120 includes a modem and a codec. The codec includes a data codec for processing packet data, etc., and an audio codec for processing an audio signal, such as a voice. An audio processor 125 reproduces a received audio signal output from the audio codec of the data processor 120 or transmits a transmitted audio signal generated from a microphone to the audio codec of the data processor 120.

A key input unit 127 includes keys for inputting number and character information and function keys for setting various functions.

A memory 130 may be configured with a program memory and a data memory. The program memory stores programs for controlling a general operation of the wireless terminal and programs for controlling the resolution of an application to be adjusted to be the same as a resolution of the wireless terminal according to the embodiment of the present invention. Further, the data memory temporarily stores data generated during the execution of the programs. The memory 130 stores information, which includes information on a screen of the wireless terminal, and on a resolution of a display unit 160. Further, the memory 130 stores a plurality of applications and information on resolution of the respective applications.

A single application may provide two applications having separate resolutions for each of a horizontal mode and a vertical mode or only one application having a resolution for one of the horizontal mode or the vertical mode.

A controller 110 serves to control a general operation of the wireless terminal.

According to an embodiment of the present invention, the controller 110 controls such that the resolution of the application is adjusted to be the same as that of the wireless terminal and executed when an execution of the application is selected.

Further, according to an embodiment of the present invention, the controller 110 determines a position mode of the portable terminal when execution of the application is selected and controls such that the resolution of the application is adjusted to be the same as that of the wireless terminal when the resolution of the wireless terminal according to the position mode of the wireless terminal is different from the resolution of the application.

Further, according to an embodiment of the present invention, when the resolution of the wireless terminal according to the position mode of the wireless terminal is different from the resolution of the application, the controller 110 controls such that a horizontal ratio and a vertical ratio according to the position mode of the wireless terminal are calculated and the resolution of the application is adjusted to the horizontal ratio and the vertical ratio according to the position mode of the wireless terminal.

Further, according to an embodiment of the present invention, when the position mode of the wireless terminal is a horizontal mode, the controller 110 controls such that a horizontal ratio and a vertical ratio in the horizontal mode are calculated and the resolution of the application is adjusted to the horizontal ratio and the vertical ratio in the horizontal mode. In this case, the controller 110 controls such that the horizontal ratio in the horizontal mode of the wireless terminal is calculated as a horizontal resolution of the wireless terminal/horizontal resolution of the application, and the vertical ratio in the horizontal mode is calculated as a vertical resolution of the wireless terminal/vertical resolution of the application.

Further, according to an embodiment of the present invention, when the position mode of the wireless terminal is a vertical mode, the controller 110 controls such that a horizontal ratio and a vertical ratio in the vertical mode are calculated and the resolution of the application is adjusted to the horizontal ratio and the vertical ratio in the vertical mode. In this case, the controller 110 calculates the horizontal ratio as the ratio of the horizontal resolution of the wireless terminal/the horizontal resolution of the application, and the vertical ratio as the ratio of the vertical resolution of the wireless terminal/the vertical resolution of the application in the vertical mode of the wireless terminal.

The controller 110 includes a resolution adjustor 111, and calculates the horizontal ratio and the vertical ratio according to the position mode of the wireless terminal through the resolution adjustor 111 and adjust the resolution of the application to be the same as that of the wireless terminal by applying the calculated horizontal ratio and vertical ratio to the resolution of the application.

A position determiner 170 determines a current position of the wireless terminal through a gravity sensor, etc., and transmits a position signal notifying the controller 110 of the current position of the wireless terminal.

A camera unit 140 photographs image data, and includes a camera sensor for converting a photographed optical signal to an electrical signal and a signal processor for converting an analog image signal photographed by the camera sensor to digital data. Here, it is assumed that the camera sensor is a Charge Coupled Device (CCD) sensor or a Complementary Metal-Oxide-Semiconductor (CMOS) sensor, and the signal processor may be implemented with a Digital Signal Processor (DSP). Further, the camera sensor may be integrally formed with or independently formed from the signal processor.

An image processor 150 performs Image Signal Processing (ISP) for displaying an image signal output from the camera unit 140 on the display unit 160, and the ISP performs functions including gamma correction, interpolation, spatial change, image effect, image scale, Auto White Balance (AWB), Auto Exposure (AE), Auto Focus (AF), etc. Accordingly, the image processor 150 processes the image signal output from the camera unit 140 in units of frames and outputs image data in units of frames in accordance with a property and a size of the display unit 160. Further, the image processor 150 includes an image codec and performs a function of compressing the image data in units of frames displayed on the display unit 160 according to a determined scheme or reconstructing the compressed image data in units of frames into an original image data in units of frames. Here, the image codec may include a Joint Photographic Experts Group (JPEG) codec, Motion Picture Experts Group 4 (MPEG4) codec, a Wavelet codec, etc. It is assumed that the image processor 150 has an On Screen Display (OSD) function, and the image processor 150 may output OSD data in accordance with a size of a displayed screen under the control of the controller 110.

The display unit 160 displays an image signal output from the image processor 150 on a screen and user data output from the controller 110. The display unit 160 may employ a Liquid Crystal Display (LCD), and in this case, the display unit 160 may include an LCD controller, a memory for storing image data, and an LCD diode. When the LCD is implemented as a touch screen, the LCD may function as an input unit. In this case, the display unit 160 may display keys similar to the key input unit 127.

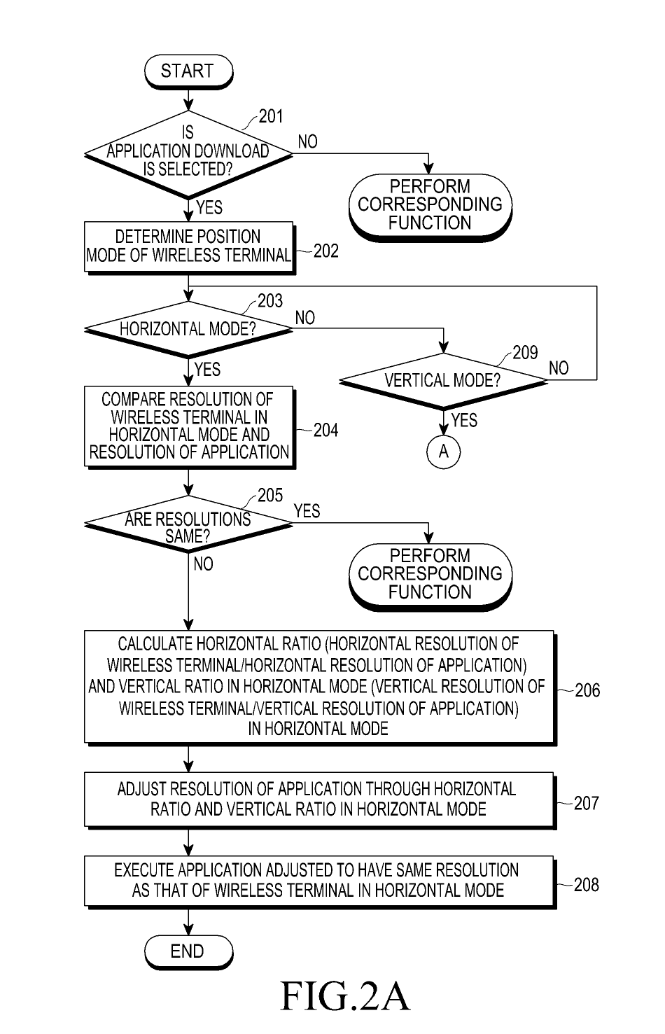

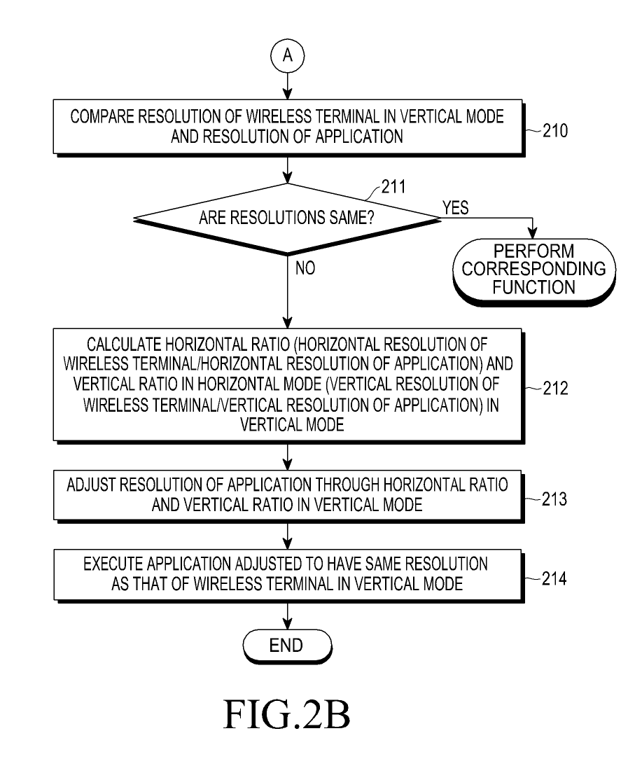

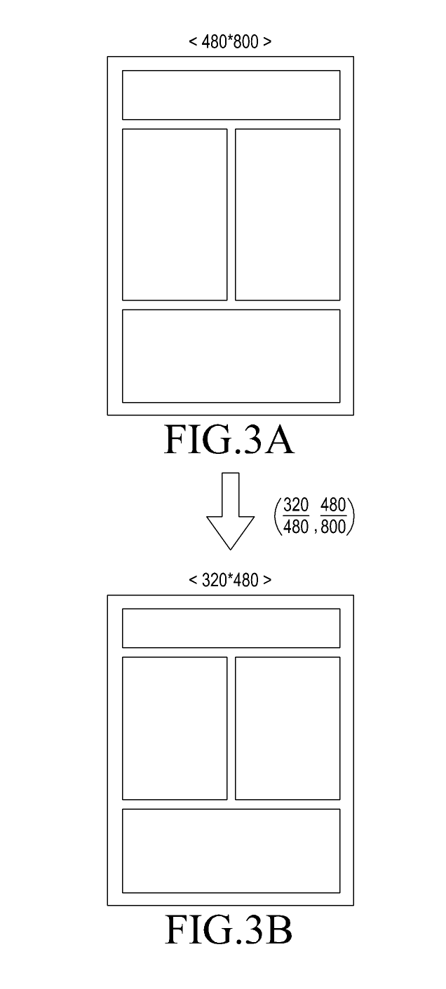

An operation of automatically adjusting resolution of an application in a wireless terminal will be described with reference to FIGS. 2 and 3 in detail.

FIGS. 2A and 2B are flowcharts illustrating a process of adjusting a resolution of an application in a wireless terminal according to an embodiment of the present invention, and FIGS. 3A and 3B illustrate the process of FIGS. 2A and 2B.

Referring to FIGS. 2A and 2B, when execution of a specific application is selected in the wireless terminal, the controller 110 detects the selection of the execution of the specific application in step 201 and proceeds to step 202 to determine a current position of the wireless terminal through a position signal received from the position determiner 170.

When it is determined that the current position of the wireless terminal is in a horizontal mode, the controller 110 detects the horizontal mode of the wireless terminal in step 203 and proceeds to step 204 to compare a resolution of the wireless terminal in the horizontal mode and a resolution of the specific application.

When the resolution of the wireless terminal in the horizontal mode of the wireless terminal is different from the resolution of the specific application, the controller 110 detects the difference between the resolution of the wireless terminal and the resolution of the specific application and proceeds to step 206 calculate a horizontal ratio and a vertical ratio in the horizontal mode of the wireless terminal.

In step 206, the controller 110 calculates the horizontal ratio in the horizontal mode of the wireless terminal as the ratio of “horizontal resolution of the wireless terminal/horizontal resolution of the specific application” and the vertical ratio in the horizontal mode of the wireless terminal as the ratio of “a vertical resolution of the wireless terminal/a vertical resolution of the specific application”.

In step 206, when the controller 110 completes the calculation of the horizontal ratio and the vertical ratio in the horizontal mode of the wireless terminal, the controller 110 adjusts the resolution of the specific application in accordance with the calculated horizontal ratio and vertical ratio in step 207. Then, the controller 110 proceeds to step 208 to execute the specific application which has been adjusted to have the same resolution as that of the wireless terminal in the horizontal mode of the wireless terminal.

Otherwise, when it is determined that the current position of the wireless terminal is not in the horizontal mode in step 203, the controller 110 detects the vertical mode of the wireless terminal in step 209 and proceeds to step 210 to compare the resolution of the wireless terminal in the vertical mode and the resolution of the specific application.

When the resolution of the wireless terminal in the vertical mode of the wireless terminal is different from the resolution of the specific application, the controller 110 detects the difference between the resolution of the wireless terminal and the resolution of the specific application and proceeds to step 212 to calculate a horizontal ratio and a vertical ratio in the vertical mode of the wireless terminal.

In step 212, the controller 110 calculates the horizontal ratio in the vertical mode of the wireless terminal as the ratio of “a horizontal resolution of the wireless terminal/a horizontal resolution of the specific application” and the vertical ratio in the vertical mode of the wireless terminal as the ratio of “vertical resolution of the wireless terminal/vertical resolution of the specific application”.

In step 212, when the controller 110 completes the calculation of the horizontal ratio and the vertical ratio in the vertical mode of the wireless terminal, the controller 110 adjusts the resolution of the specific application in accordance with the calculated horizontal ratio and vertical ratio in step 213. Then, the controller 110 proceeds to step 214 to execute the specific application which has been adjusted to have the same resolution as that of the wireless terminal in the vertical mode of the wireless terminal.

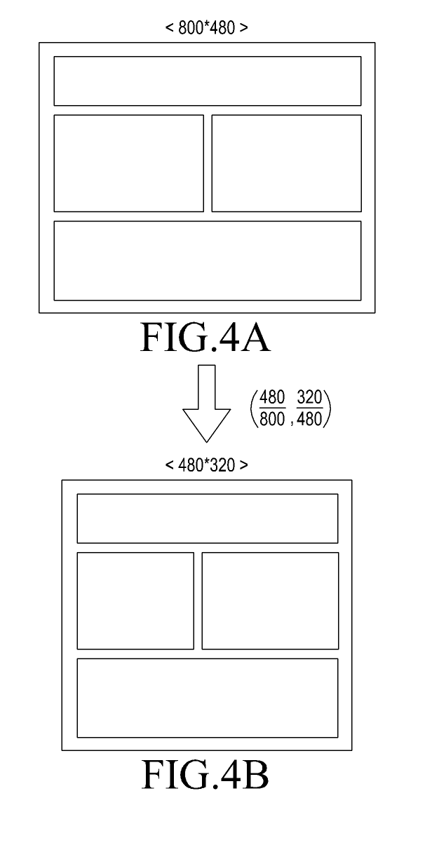

Referring to FIGS. 3 and 4, which illustrate the process of FIGS. 2A and 2B, an example in which one application provides two applications having separate resolutions for each of the horizontal mode and the vertical mode will be described.

FIGS. 3A and 3B illustrate an operation of adjusting the resolution of the application to be the same as that of the wireless terminal when the current position of the wireless terminal is in the vertical mode.

When the resolution of the wireless terminal is 320×480 and the resolution of the application for providing the vertical mode is 480×800 when the current position of the wireless terminal is in the vertical mode, the controller 110 obtains a horizontal ratio value “2/3” through the ratio of “the horizontal resolution “320” of the wireless terminal/the horizontal resolution “480” of the application” and a vertical ratio value “3/5” through the ratio of “the vertical resolution “480” of the wireless terminal/the vertical resolution “800” of the application”. Then, the controller 110 executes the application having the same resolution as the resolution 320×480 in the vertical mode of the wireless terminal as illustrated in FIG. 3B by applying each of the calculated horizontal ratio “2/3” and the vertical ratio “3/5” to the resolution “480×800” provided for the vertical mode of the application as illustrated in FIG. 3A.

FIG. 4 illustrates an operation of adjusting the resolution of the application to have the same resolution as that of the wireless terminal when the current position of the wireless terminal is in the horizontal mode.

When the resolution of the wireless terminal is 480×320 and the resolution of the application for providing the vertical mode is 800×480 in the case in which the current position of the wireless terminal is in the horizontal mode, the controller 110 obtains a horizontal ratio value “3/5” through the ratio of “the horizontal resolution “480” of the wireless terminal/the horizontal resolution “800” of the application” and a vertical ratio value “2/3” through the ratio of “the vertical resolution “320” of the wireless terminal/the vertical resolution “480” of the application”. Then, the controller 110 executes the application having the same resolution as the resolution 480×320 in the horizontal mode of the wireless terminal as illustrated in FIG. 4B by applying each of the calculated horizontal ratio “3/5” and the vertical ratio “2/3” to the resolution “800×480” provided for the horizontal mode of the application as illustrated in FIG. 4A.

As described above, the present invention first determines the current position of the wireless terminal and adjusts the resolution of the application by applying different scaling ratios to the resolution of the application according to the current position, e.g. the horizontal mode or the vertical mode, of the wireless terminal. In this case, the present invention adjusts the resolution of the application by applying each of the horizontal ratio and the vertical ratio to the resolution of the application, so that it is possible to clearly display the GUI of the resolution-adjusted application and display the resolution-adjusted application in the entirety of the display unit of the wireless terminal.

It will be appreciated that the method of adjusting the resolution of the application to have the same resolution as that of the wireless terminal according to the embodiment of the present invention may be implemented by hardware, software, or a combination of hardware and software. The software may be stored in a volatile or non-volatile storage device including Read Only Memory (ROM) regardless of whether it is desirable to have a deletable function or a re-writable function, a memory, such as RAM, a memory chip, a device, an integrated circuit, a storage medium such as CDs, DVDs, magnetic disks, or magnetic tapes, writable optically or magnetically and readable by a machine (e.g. a computer). It will be understood that the apparatus and the method of adjusting the resolution of the application in the wireless terminal may be implemented by a computer, as well as the wireless terminal, including the controller and the memory, and the memory is one example of the machine-readable storage medium appropriate for storing a program or programs including instructions implementing the embodiments of the present invention. Accordingly, the present invention includes a program including codes for implementing the apparatus or the method defined in any one of the claims and the machine (computer, etc.) readable storage medium for storing the program. Further, the program may be electrically carried through a medium, such as a communication signal, transferred by a wired or wireless connection, and the present invention appropriately includes the equivalent thereto.

Further, the method of adjusting the resolution of the application to have the same resolution as that of the wireless terminal according to the embodiment of the present invention may be implemented in all devices capable of adjusting the resolution of the application, as well as a portable wireless terminal, a hand-held terminal, a wireless terminal, and a mobile terminal. All devices to which the present invention may be applied may receive and store the program from a wired or wirelessly connected program providing device. The program providing device may include a memory including a program including instructions through which a device to which the present invention may be applied can adjust the resolution of an application and information necessary for adjusting the resolution of the application, a communication unit for wired or wireless communication with the device, and a controller for transmitting a request of the device or automatically transmitting a corresponding program to a transmission/reception device.

While the present invention has been shown and described with reference to certain embodiments of the wireless terminal, it will be understood by those skilled in the art that various changes in form and details may be made therein without departing from the spirit and scope of the invention. Accordingly, the scope of the present invention is not defined by the aforementioned embodiments, but by the claims and their equivalents.

What is claimed is:

1. An apparatus for adjusting a resolution of an application in a wireless terminal, the apparatus comprising:
a display unit for displaying an application having a resolution adjusted to be identical to a resolution of a wireless terminal; and
a controller for controlling such that when execution of the application is selected, the application is executed by adjusting the resolution of the application to be identical to the resolution of the wireless terminal.

2. The apparatus as claimed in claim 1, wherein, when execution of the application is selected, a position mode of the wireless terminal is determined by the controller and the resolution of the application is adjusted to be identical to the resolution of the wireless terminal when the resolution of the wireless terminal according to the position mode of the wireless terminal is different from the resolution of the application.

3. The apparatus as claimed in claim 2, wherein, when the resolution of the wireless terminal according to the position mode of the wireless terminal is different from the resolution of the application, a horizontal ratio and a vertical ratio according to the position mode of the wireless terminal are calculated by the controller and the resolution of the application is adjusted to the horizontal ratio and the vertical ratio according to the position mode of the wireless terminal.

4. The apparatus as claimed in claim 3, wherein, when the wireless terminal is in a horizontal mode, a horizontal ratio and a vertical ratio according to the horizontal mode of the wireless terminal are calculated by the controller and the resolution of the application is adjusted to the horizontal ratio and the vertical ratio in the horizontal mode of the wireless terminal.

5. The apparatus as claimed in claim 3, wherein, when the wireless terminal is in a vertical mode, a horizontal ratio and a vertical ratio according to the vertical mode of the wireless terminal are calculated by the controller and the resolution of the application is adjusted to the horizontal ratio and the vertical ratio in the vertical mode of the wireless terminal.

6. The apparatus as claimed in claim 2, wherein the controller calculates the horizontal ratio as the ratio of “horizontal resolution of the wireless terminal/vertical resolution of the application” and the vertical ratio as the ratio of “vertical resolution of the wireless terminal/vertical resolution of the application”.

7. A method of adjusting a resolution of an application in a wireless terminal, the method comprising:
when execution of an application is selected, comparing a resolution of the application and a resolution of the wireless terminal;
when the resolution of the wireless terminal is different from the resolution of the application, executing the application by adjusting the resolution of the application to be identical to the resolution of the wireless terminal.

8. The method as claimed in claim 7, wherein comparing the resolution of the application and the resolution of the wireless terminal comprises:
when the execution of the application is selected, determining a position mode of the wireless terminal;
when the position mode of the wireless terminal is a horizontal mode, comparing whether the resolution of the wireless terminal in the horizontal mode is identical to the resolution of the application; and
when the position mode of the wireless terminal is a vertical mode, comparing whether the resolution of the wireless terminal in the vertical mode is identical to the resolution of the application.

9. The method as claimed in claim 7, wherein executing the application comprises:
when the resolution of the wireless terminal is different from the resolution of the application when a position mode of the wireless terminal is a horizontal mode, calculating a horizontal ratio and a vertical ratio in the horizontal mode; and
adjusting the resolution of the application to the horizontal ratio and the vertical ratio in the horizontal mode.

10. The method as claimed in claim 9, wherein the horizontal ratio is calculated as the ratio of “horizontal resolution of the wireless terminal/horizontal resolution of the application” and the vertical ratio as the ratio of “vertical resolution of the wireless terminal/vertical resolution of the application”.

11. The method as claimed in claim 7, wherein executing the application comprises:
when the resolution of the wireless terminal is different from the resolution of the application when a position mode of the wireless terminal is a vertical mode, calculating a horizontal ratio and a vertical ratio in the vertical mode; and
adjusting the resolution of the application to the horizontal ratio and the vertical ratio in the vertical mode.

12. The method as claimed in claim 11, wherein the horizontal ratio is calculated as the ratio of “horizontal resolution of the wireless terminal/horizontal resolution of the application” and the vertical ratio is calculated as the ratio of “vertical resolution of the wireless terminal/vertical resolution of the application”.
